(19) United States
(12) Patent Application Publication
(10) Pub. No.: US 2006/0255918 A1
(43) Pub. Date: Nov. 16, 2006

(54) Method and system for detecting when a golf club is a pre-determined distance from an area

(76) Inventors: Jonathan Bernstein, New York, NY (US); Frederick Herbst, Garden City, NY (US)

Correspondence Address: BINGHAM MCCUTCHEN LLP, 3000 K STREET, NW, BOX IP, WASHINGTON, DC, 20007, US

(21) Appl. No.: 11/126,358

(22) Filed: May 11, 2005

(51) Int. Cl. H04Q 5/22; G08B 13/14

(52) U.S. Cl. 340/10.6; 340/568.6

(57) ABSTRACT

A device periodically transmits a request to the RFID tag affixed to each golf club in the set of golf clubs. If a golf club is within a pre-determined distance from the device, the RFID tag affixed to the golf club will respond to the request. If the golf club is not within the pre-determined distance from the device, the RFID tag affixed to the golf club will not issue a response. The failure of a golf club to respond within a specified time interval will result in the display of a message on the device indicating that a golf club is unaccounted for. The device can transmit a signal to a handheld device wearable on a golf course reporting the missing golf club directly to the owner of the golf club who is wearing the handheld device.

### BACKGROUND OF THE INVENTION

1. Field of the Invention:

The present invention relates to a method and system for detecting a missing object. More particularly, the present invention relates to a method and system for detecting when a golf club is a pre-determined distance from an area.

2. Description of the Prior Art:

It is not unusual during a round of golf for a golf club to be left at a particular hole of a course. This typically occurs when a golfer retrieves more than one golf club from their golf bag to perform a shot at a hole and inadvertently leaves one of the golf clubs at the hole once the shot is complete. The golfer will ultimately realize, at some point in time, that the golf club is missing from his golf bag and have to retrace his or her steps in order to locate the missing golf club. This can create a substantial delay in completing the round of golf as well as a feeling of general frustration by the golfer. In addition, if the golf club cannot be located, an added expense is also created since the missing club will have to be replaced.

Accordingly, there is a need for a method and a system for detecting when a golf club is missing. There is also a need for the method and the system to signal when a golf club is a pre-determined distance from an area. There is a need for the method and system to enable a golfer to provide each golf club in a golf bag with a Radio Frequency Identification Tag (“RFID”). There is also a need for the method and system to associate the RFID tag in each golf club with a text entry corresponding to the type of the golf club. There is a need for the method and system to textually indicate that the golf club is a pre-determined distance from a golf bag. There is a need for the method and system to report that the golf club is missing from the golf bag to a handheld device wearable on a golf course.

### SUMMARY OF THE INVENTION

According to embodiments of the present invention, a method and system for detecting that at least one golf club in a set of golf clubs is missing from an area are provided. Each golf club in a set of golf clubs is affixed with an RFID tag. A device periodically transmits a request to the RFID tag affixed to each golf club in the set of golf clubs. In an embodiment of the present invention, the device is coupled to a golf bag. If a golf club is within a pre-determined distance from the device, the RFID tag affixed to the golf club will respond to the request. If the golf club is not within the pre-determined distance from the device, the RFID tag affixed to the golf club will not issue a response. The failure of a golf club to respond within a specified time interval will result in the display of a message on the device indicating that a golf club is unaccounted for. The device can transmit a signal to a handheld device wearable on a golf course reporting the missing golf club directly to the owner of the golf club who is wearing the handheld device.

### BRIEF DESCRIPTION OF THE DRAWINGS

The above described features and advantages of the present disclosure will be more fully appreciated with reference to the detailed description and appended figures in which:

FIG. 1 depicts an exemplary functional block diagram of a device in which the present disclosure can find application;

FIG. 2 depicts an exemplary system depicted in FIG. 1;

FIG. 3 depicts an exemplary system depicted in FIG. 1; and

FIG. 4 depict an exemplary method for detecting that a golf club is missing from an area according to the present invention.

### DETAILED DESCRIPTION OF THE INVENTION

The present invention is now described more fully hereinafter with reference to the accompanying drawings that show exemplary embodiments of the invention. The present invention, however, may be embodied in many different forms and should not be construed as limited to the embodiments set forth herein. Appropriately, these embodiments are provided so that this disclosure will be thorough and complete, and will fully convey the scope of the present invention.

According to embodiments of the present invention, a method and system for detecting that at least one golf club in a set of golf clubs is missing from an area are provided. Each golf club in a set of golf clubs is affixed with an RFID tag. A device periodically transmits a request to the RFID tag affixed to each golf club in the set of golf clubs. In an embodiment of the present invention, the device is coupled to a golf bag. If a golf club is within a pre-determined distance from the device, the RFID tag affixed to the golf club will respond to the request. If the golf club is not within the pre-determined distance from the device, the RFID tag affixed to the golf club will not issue a response. The failure of a golf club to respond within a specified time interval will result in the display of a message on the device indicating that a golf club is unaccounted for. The device can transmit a signal to a handheld device wearable on a golf course reporting the missing golf club directly to the owner of the golf club who is wearing the handheld device.

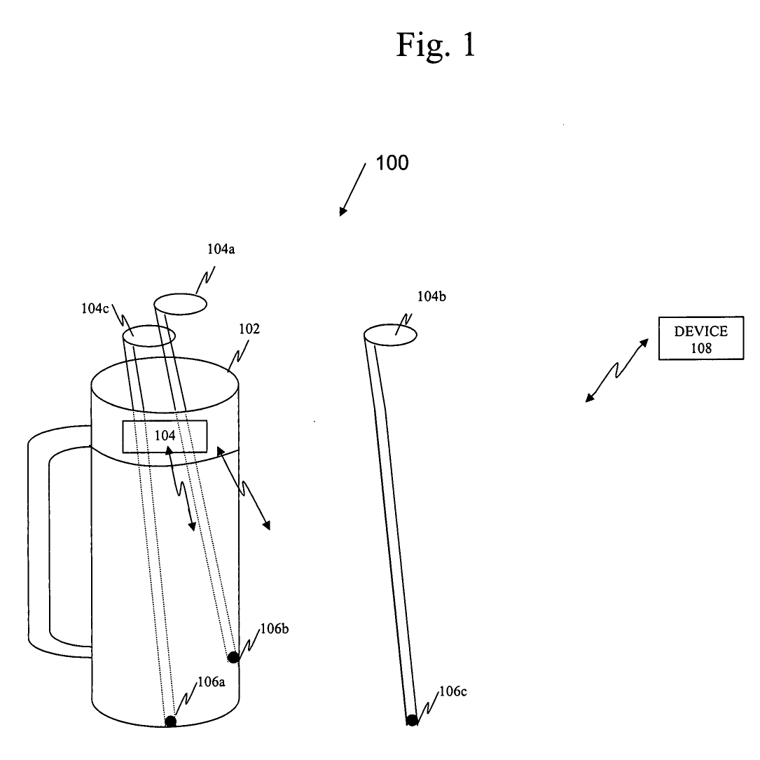

FIG. 1 is an exemplary diagram of a system 100 in which the present invention may be implemented. System 100 includes a set of clubs 104a-104c, a set of RFID tags 106a-106c, an interrogation device 104 coupled to a golf bag 102 and a device 108. In the FIG. 1 embodiment of the present invention, an RFID tag 106 is fixedly coupled to the handle of each golf club 104a-104c. One having ordinary skill in the art would recognize that an RFID tag can be coupled to any portion of a golf club that would not cause damage to the RFID tag or interfere with a golfer's ability to use the golf club in the manner for which it was intended. Each RFID tag is operable to communicate with interrogation device 104, within a pre-determined distance, in response to a request from interrogation device 104. In the FIG. 1 embodiment of the present invention, interrogation device 104 is coupled to an object, such as golf bag 102, and is operable to communicate with RFID tags 106a-106c and device 108. In the FIG. 1 embodiment of the present invention, device 108 is a handheld device wearable by a golfer and operable to communicate with interrogation device 104 and a network (not shown).

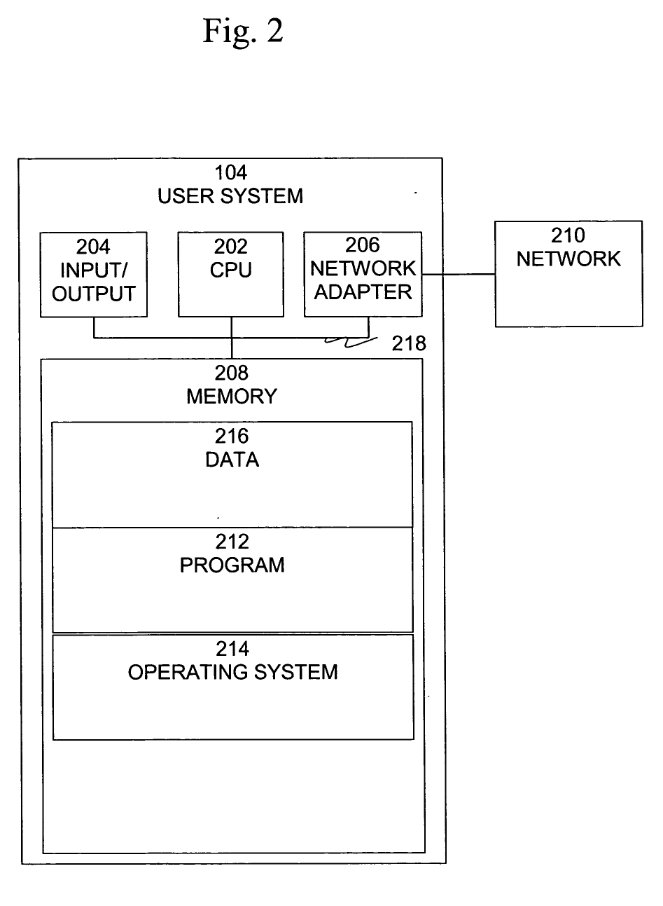

FIG. 2 is an exemplary diagram of an interrogation device 104 shown in FIG. 1 in which the present invention can find application. The interrogation device may include CPU 202, connected by a bus 218 or other suitable interface means to memory 208. In the FIG. 2 embodiment of the present invention, CPU 202 is a microprocessor, such as an INTEL PENTIUM) or AMD®) processor, but may be any processor that executes program instructions in order to carry out the functions disclosed herein. The functions include, but are not limited to, registering each RFID tag coupled to each golf club in a set of golf clubs, such as golf clubs 104a-104c, periodically polling each RFID tag coupled to each golf club in the set of golf clubs, receiving a response from each polled RFID tag that is within a pre-determined distance, displaying a text message indicating that at least one golf club associated with an RFID tag is not within the pre-determined distance and report to device 108 that the at least one golf club is not within the pre-determined distance. In an embodiment of the present invention, the code for the RFID tag that is not with the pre-determined distance is displayed. In an embodiment of the present invention, the type of club associated with the RFID tag that is not within the pre-determined distance is displayed.

The interrogation device 104 can also include input/output circuitry 204 and network transceiver 206. Input/output circuitry 204 enables interaction with and execution of instructions by interrogation device 104 as directed by a user. The input/output circuitry 204 includes input devices, such as trackball, mice, touchpads and keyboards, and output devices, such as printers and monitors. The network transceiver 206 communicates with a network 210, RFID tags 106a-106c and device 108.

As shown in FIG. 2, the various components of the interrogation device 104 communicate through a bus or similar architecture 218. Accordingly, memory 208 is disposed in communication with CPU 202 through bus 218. Memory 208 includes Interrogation Program 212, operating system 214 and data 216. Operating system 114 provides overall system functionality. The Interrogation Program 212 enables registering of each RFID tag coupled to each golf club in a set of golf clubs, such as golf clubs 104a-104c, periodic polling of each RFID tag coupled to each golf club in the set of golf clubs, receiving a response from each polled RFID tag that is within a pre-determined distance of device 108, displaying a text message indicating that at least one golf club associated with an RFID tag is not within the pre-determined distance of device 108 and reporting to device 108 that the at least one golf club is not within the pre-determined distance. In an embodiment of the present invention, the identification code for the RFID tag that is not with the pre-determined distance is displayed. In an embodiment of the present invention, the type of club associated with the RFID tag that is not within the pre-determined distance is displayed.

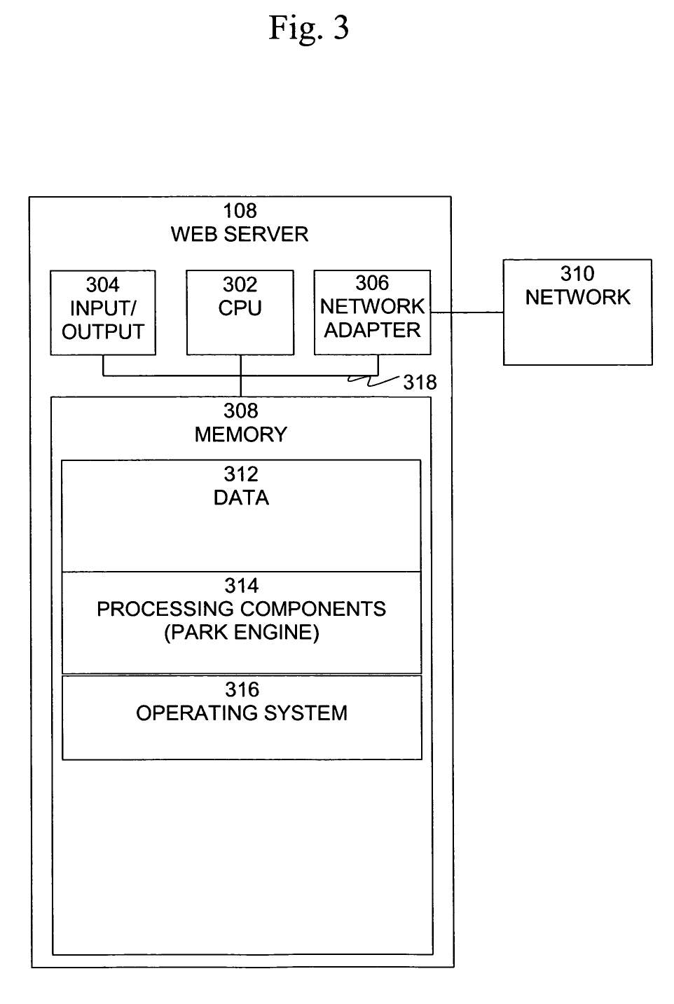

FIG. 3 is an exemplary diagram of a handheld device 108 shown in FIG. 1 in which the present invention can find application. The handheld device 108 may include CPU 302, connected by a bus 318 or other suitable interface means to memory 308. In the FIG. 3 embodiment of the present invention, CPU 302 is a microprocessor, such as an INTEL PENTIUM® or AMD® processor, but may be any processor that executes program instructions in order to carry out the functions disclosed herein. The functions include, but are not limited to, receiving a signal indicating that at least one golf club associated with an RFID tag is not within a pre-determined distance of interrogation device 104 and displaying a text message indicating that at least one golf club associated with an RFID tag is not within the pre-determined distance of interrogation device 104.

The handheld device 108 can also include input/output circuitry 304 and network transceiver 306. Input/output circuitry 304 enables interaction with and execution of instructions by handheld device 108 as directed by a user. The input/output circuitry 304 includes input devices, such as trackball, mice, touchpads and keyboards, and output devices, such as printers and monitors. The network transceiver 306 communicates with the interrogation device 104 and a network 210.

As shown in FIG. 3, the various components of the handheld device 108 communicate through a bus or similar architecture 318. Accordingly, memory 308 is disposed in communication with CPU 302 through bus 318. Memory 308 includes Program 312, operating system 314 and data 316. Operating system 314 provides overall system functionality. The Program 312 enables device 108 to receive a signal indicating that at least one golf club associated with an RFID tag is not within a pre-determined distance of interrogation device 104 and display a text message indicating that at least one golf club associated with an RFID tag is not within the pre-determined distance of interrogation device 104.

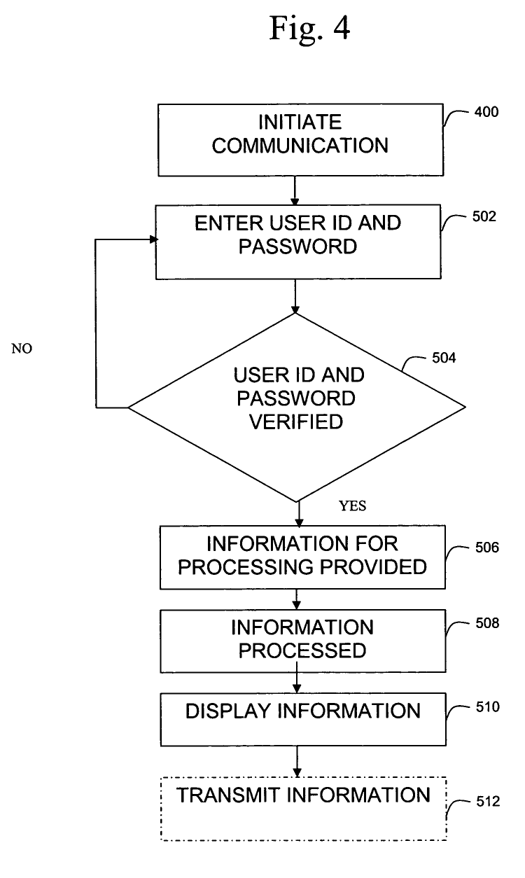

FIG. 4 depicts an exemplary method for locating a lost golf club according to the present invention. FIG. 4 will be best understood when read in conjunction with FIG. 1. The method begins at step 400. In step 400, the interrogation device 104 is activated. The activation of the interrogation device 104 initiates the emission of a RF signal by the interrogation device 104 that activates each of the RFID Tags 106a-106b.

In step 402, an inventory of golf clubs is taken. The inventory is performed by each RFID tag 106a-106c transmitting their respective identification codes to the interrogation device 104. The identification codes will be transmitted so as to prevent an RFID tag from transmitting its identification code when another identification code is being transmitted. The identification codes of each RFID tag is stored in memory of device 104. In an embodiment of the present invention, the type of golf club that an RFID tag is affixed to is stored in association with the identification code of the RFID tag.

In step 404, a period of time is allowed to elapse from the time the last identification code was transmitted to device 104. In step 406, interrogation device 104 transmits an RF signal to the RFID tags 106a-106c. In step 408, it is determined whether each of the RFID tags 106a-106c responded to the RF signal. Determining whether each of the RFID tags 106a-106c responded to the RF signal includes, but is not limited to, receiving an RF signal from each RFID tag that is within a pre-determined distance from interrogation device 104, and comparing the identification code encoded in each of the received RF signals with identification codes in a list of identification codes for the RFID tags stored in device 104. If so, the method returns to step 404. If not, the method proceeds to step 410.

In step 410, the interrogation device 104 displays a text message that a golf club is unaccounted for. In an embodiment of the invention, the text message corresponds to the identification code of the RFID tag coupled to the missing golf club. In an embodiment of the present invention, the text message corresponds to the type of the missing golf club. In step 412, a reporting signal is transmitted from the interrogation device 104 to device 108. In step 414, the device 108 displays a text message that a golf club is unaccounted for.

While specific embodiments of the present disclosure have been illustrated and described, it will be understood by those having ordinary skill in the art that changes can be made to those embodiments without departing from the spirit and scope of the disclosure.

What we claim is:

1. A method of detecting when a golf club is a predetermined distance from an area, the method comprising:
transmitting at least one interrogation RF signal to a set of golf clubs;
determining whether a response signal is detected for each of the golf clubs in the set of golf clubs in response to the at least one interrogation RF signal;
if not, retrieving the identification code associated with at least one undetected golf club;
transmitting a reporting signal indicating that the at least one golf club is missing; and
displaying a FIRST message indicating that the at least one golf club is missing.

2. The method according to claim 1, wherein the first message is an identification code.

3. The method according to claim 1, wherein the first message is a type of golf club.

4. The method according to claim 1, further comprising transmitting an inventory RF signal to the set of golf clubs.

5. The method according to claim 4, further comprising receiving from each of the golf clubs in the set of golf clubs a signal encoded with an identification code.

6. The method according to claim 5, wherein each identification code is unique.

7. The method according to claim 5, further comprising storing each of the identification codes.
